(19) United States
(12) Patent Application Publication
(10) Pub. No.: US 2026/0181161 A1
(43) Pub. Date: Jun. 25, 2026

(54) METHOD FOR EXTRAPOLATION FILTER-BASED INTRA PREDICTION (EIP) FUSION MODE

(71) Applicant: Alibaba (China) Co., Ltd., Hangzhou (CN)

(72) Inventors: Jiaxu ZHANG, Beijing (CN); Zixiang ZHANG, Beijing (CN); Xinwei LI, Beijing (CN); Jie CHEN, Beijing (CN); Ru-ling LIAO, Sunnyvale, CA (US); Yan YE, San Diego, CA (US)

(21) Appl. No.: 19/391,768

(22) Filed: Nov. 17, 2025

Related U.S. Application Data
(60) Provisional application No. 63/737,718, filed on Dec. 22, 2024.

(51) Int. Cl. H04N 19/159; H04N 19/176; H04N 19/184

(52) U.S. Cl. CPC H04N 19/159; H04N 19/176; H04N 19/184

(57) ABSTRACT

The present disclosure provides a method of encoding a video sequence. The method includes receiving a video sequence; encoding the video sequence using an extrapolation filter-based intra prediction (EIP) fusion mode. The encoding the video sequence using the EIP fusion mode includes obtaining a first predictor by an extrapolation filter-based intra prediction (EIP) mode; obtaining a second predictor by an intra prediction mode; generating a fused predictor by fusing the first predictor and the second predictor; and predicting one or more pictures using the fused predictor.

### CROSS-REFERENCE TO RELATED APPLICATIONS

This disclosure claims the benefits of priority to U.S. Provisional Application No. 63/737,718, filed on Dec. 22, 2024, which is incorporated herein by reference in its entirety.

### TECHNICAL FIELD

The present disclosure generally relates to video processing, and more particularly, to methods for extrapolation filter-based intra prediction (EIP) fusion mode.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transformation, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a method for encoding a video sequence. In some embodiments, the method includes: receiving a video sequence; encoding the video sequence using an extrapolation filter-based intra prediction (EIP) fusion mode. The encoding the video sequence using the EIP fusion mode includes: obtaining a first predictor by an extrapolation filter-based intra prediction (EIP) mode; obtaining a second predictor by an intra prediction mode; generating a fused predictor by fusing the first predictor and the second predictor; and predicting one or more pictures using the fused predictor.

Embodiments of the present disclosure provide a method for decoding a bitstream. In some embodiments, the method includes receiving a bitstream; and decoding the bitstream to output a video sequence using an extrapolation filter-based intra prediction (EIP) fusion mode. The decoding the bitstream using the EIP fusion mode includes obtaining a first predictor by an extrapolation filter-based intra prediction (EIP) mode; obtaining a second predictor by an intra prediction mode; generating a fused predictor by fusing the first predictor and the second predictor; and predicting one or more pictures using the fused predictor.

Embodiments of the present disclosure provide a method for signaling a bitstream. In some embodiments, the method includes: receiving a video sequence; encoding the video sequence using an extrapolation filter-based intra prediction (EIP) fusion mode; and signaling a bitstream that is generated based on the encoding. The encoding the video sequence using the EIP fusion mode includes: obtaining a first predictor by an extrapolation filter-based intra prediction (EIP) mode; obtaining a second predictor by an intra prediction mode; generating a fused predictor by fusing the first predictor and the second predictor; and predicting one or more pictures using the fused predictor.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an exemplary video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5 is a schematic diagram illustrating exemplary reference samples used in planar mode, according to some embodiments of the present disclosure.

FIG. 6 is a schematic diagram illustrating 67 exemplary intra prediction modes, according to some embodiments of the present disclosure.

FIG. 7 is a schematic diagram illustrating adjacent blocks (L, A, BL, AR, AL) used in the derivation of a general most probable mode (MPM) list, according to some embodiments of the present disclosure.

FIG. 8 is a schematic diagram illustrating an exemplary L shaped neighborhood for a given predicted block, according to some embodiments of the present disclosure.

FIG. 9 illustrates three exemplary extrapolation filter-based intra prediction (EIP) filter shapes, according to some embodiments of the present disclosure.

FIG. 10 illustrates three exemplary types of reference area supported in ECM, according to some embodiments of the present disclosure.

FIG. 11A and FIG. 11B illustrate examples of two possibilities of sub-partitions, respectively, according to some embodiments of the present disclosure.

FIG. 12 is a flowchart of an exemplary method of extrapolation filter-based intra prediction (EIP) fusion mode, according to some embodiments of the present disclosure.

FIG. 13 is a flowchart of another exemplary method for EIP fusion mode, according to some embodiments of the present disclosure.

FIG. 14 illustrates three exemplary template types, according to some embodiments of the present disclosure.

FIG. 15 is a flowchart of an exemplary method for performing extrapolation filter-based intra prediction (EIP) on sub-partitions, according to some embodiments of the present disclosure.

FIG. 16A and FIG. 16B illustrate exemplary processes of performing EIP prediction on two sub-partitions respectively, according to some embodiments of the present disclosure.

FIG. 17 illustrates exemplary different shapes of sub-partition, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are most concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

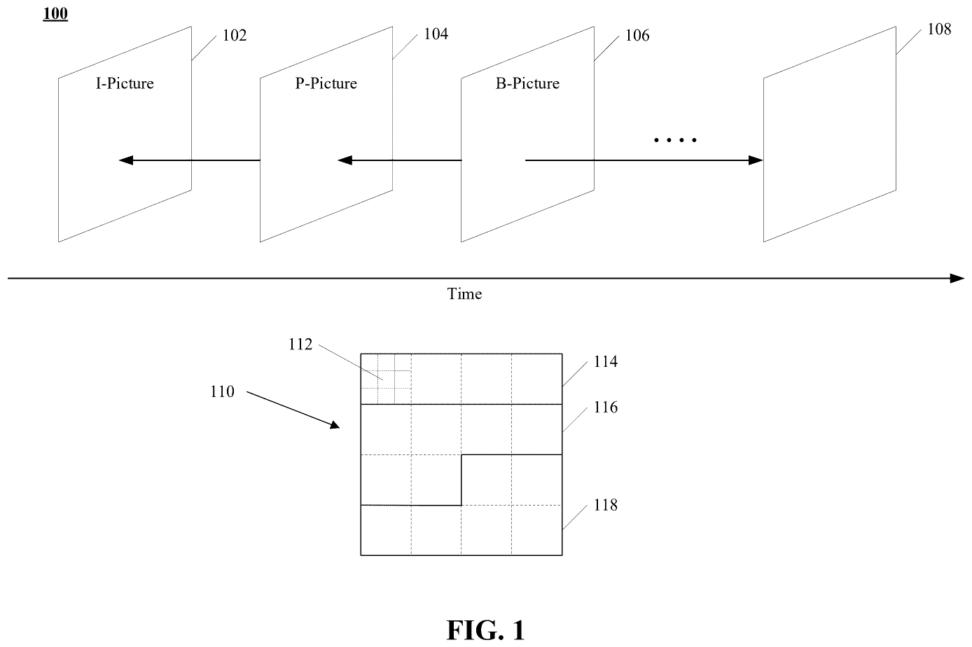

FIG. 1 illustrates structures of an exemplary video sequence 100, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) cannot be immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

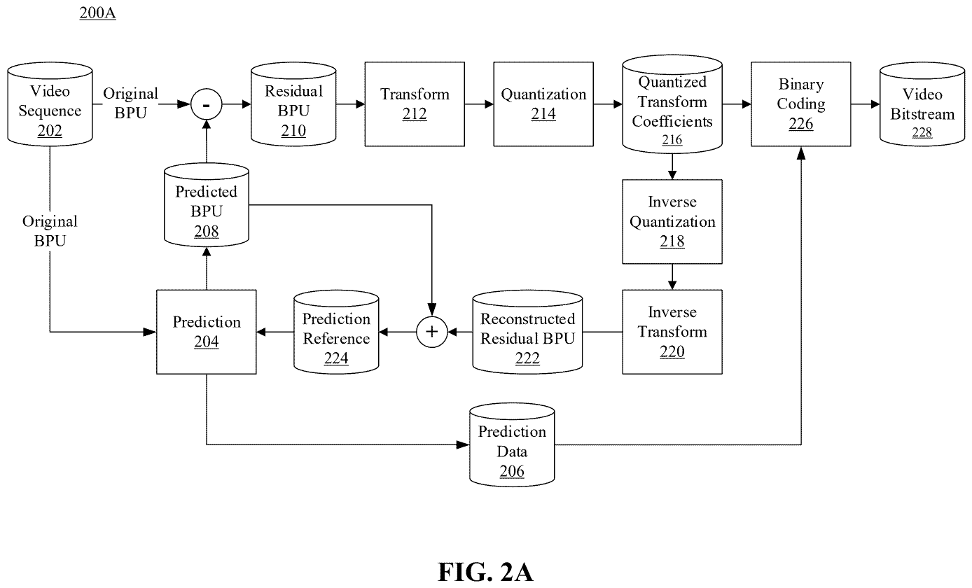

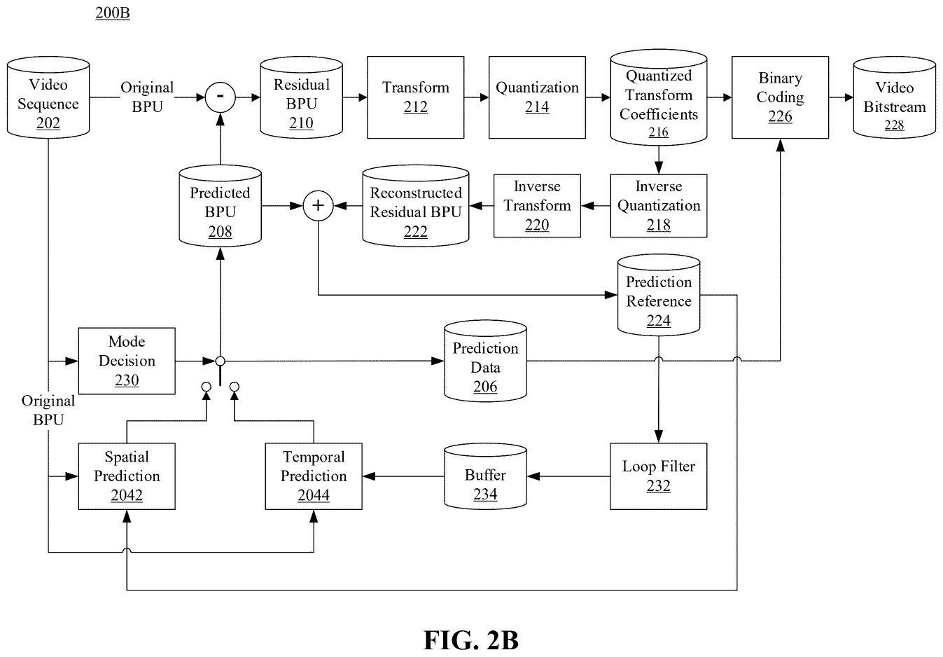

Video coding has multiple stages of operations, examples of which are shown in FIGS. 2A-2B and FIGS. 3A-3B. For each stage, the size of the basic processing units can still be too large for processing and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC) and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIG. 2A and FIG. 2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an exemplary encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224 and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization syntax element or any other syntax element of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, syntax elements of the prediction operation, a transform type at transform stage 212, syntax elements of the quantization process (e.g., quantization syntax elements), an encoder control syntax element (e.g., a bitrate control syntax element), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another exemplary encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, syntax elements of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer (DPB)”) for later use (e.g., to be used as an inter-prediction reference picture for a future picture of video sequence 202). The encoder can store one or more reference pictures in buffer 234 to be used at temporal prediction stage 2044. In some embodiments, the encoder can encode syntax elements of the loop filter (e.g., a loop filter strength) at binary coding stage 226, along with quantized transform coefficients 216, prediction data 206, and other information.

FIG. 3A illustrates a schematic diagram of an exemplary decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIG. 2A and FIG. 2B), generally, video stream 304 is not identical to video sequence 202. Similar to processes 200A and 200B in FIG. 2A and FIG. 2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, syntax elements of the prediction operation, a transform type, syntax elements of the quantization process (e.g., quantization syntax elements), an encoder control syntax element (e.g., a bitrate control syntax element), or the like. In some embodiments, if video bitstream 228 is transmitted over a network in packets, the decoder can depacketize video bitstream 228 before feeding it to binary decoding stage 302.

FIG. 3B illustrates a schematic diagram of another exemplary decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044 and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, syntax elements of the intra prediction operation, or the like. The syntax elements of the intra prediction operation can include, for example, locations (e.g., coordinates) of one or more neighboring BPUs used as a reference, sizes of the neighboring BPUs, syntax elements of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, syntax elements of the inter prediction operation, or the like. The syntax elements of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer (DPB) in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include syntax elements of the loop filter (e.g., a loop filter strength). In some embodiments, prediction data includes syntax elements of the loop filter when the prediction mode indicator of prediction data 206 indicates that inter prediction was used to encode the current BPU.

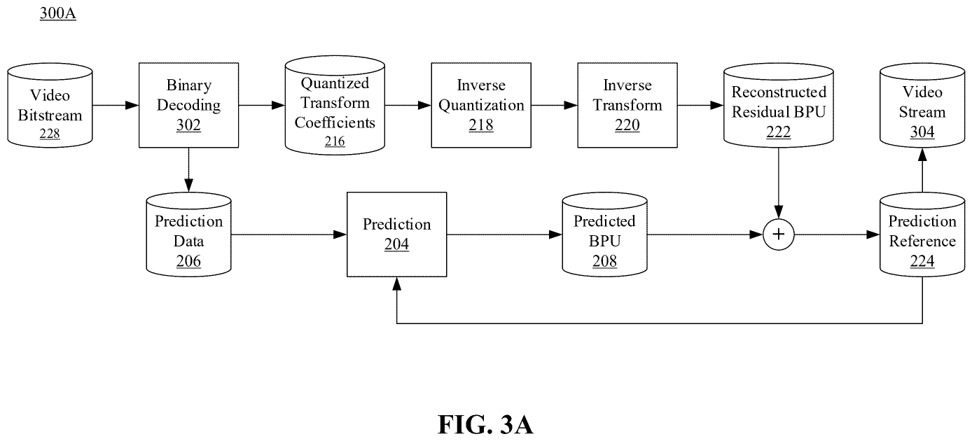

FIG. 4 is a block diagram of an exemplary apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410) and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

After VVC, the JVET starts to explore coding techniques beyond VVC using an Enhanced Compression Model (ECM). The ECM is used as a new software base for developing tools beyond the VVC standard.

First, intra prediction used in video coding is described. According to the VVC standard, the luma component can be predicted by multiple intra prediction modes. These include but are not limited to: planar mode, DC mode, angular mode, Multiple Reference Line (MRL) prediction mode, Intra Sub-partition (ISP) mode, Matrix-based Intra Prediction (MIP) mode, and Intra Block Copy (IBC) mode.

In ECM, several video compression technologies beyond VVC are being explored. In ECM, some intra prediction modes are extended. Some new intra prediction modes are added, such as Decoder-side Intra Mode Derivation (DIMD) mode, Template-based Intra Mode Derivation mode (TIMD), Template-based multiple reference line intra prediction (TMRL), intra Template Matching (intra TMP) mode and Spatial Geometric Partition mode (SGPM), etc.

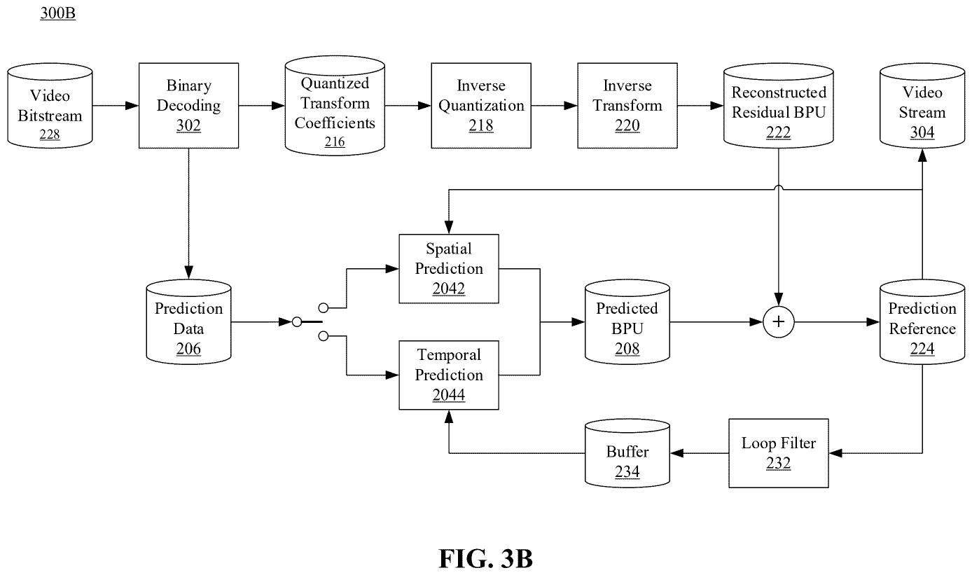

Details of the above intra prediction modes are described. In the planar mode, the predicted value of a current sample is obtained from the reconstructed values of 4 reference samples: the left reference sample in the same row as the current sample, the above reference sample in the same column as the current sample, the reference sample on the bottom-left position adjacent to the current block, and the reference sample on the top-right position adjacent to the current block. FIG. 5 is a schematic diagram illustrating exemplary reference samples used in planar mode, according to some embodiments of the present disclosure. Referring to FIG. 5, using pred (x, y) to represent the predicted value of the current sample, using H to represent the height of the current block, and using W to represent the width of the current block, then the reconstructed values of the four reference samples used in planar mode can be respectively represented as rec (−1, y), rec (x,−1), rec (−1, H) and rec (W,−1), where (x, y) represents the coordinate positions of the current sample relative to the top-left position within the current block.

The planar mode generates the predicted value of the current sample according to the Equations (1) to (3). In Equation 1, an intermediate value predV (x, y) is obtained from rec (x,−1) and rec (−1, H). In Equation 2, another intermediate value predH (x, y) is obtained from rec (−1, y) and rec (W,−1). Finally, the two intermediate values are used to generate the predicted value of the current sample according to Equation 3.

$$pred ( x , y ) = ( ( H - 1 - y ) * rec ( x , - 1 ) + ( y + 1 ) * rec ( - 1 , H ) ) << {log}_{2} W \qquad ( 1 )$$

$$pred ( x , y ) = ( ( W - 1 - x ) * rec ( - 1 , y ) + ( x + 1 ) * rec ( W , - 1 ) ) << {log}_{2} H \qquad ( 2 )$$

$$pred ( x , y ) = ( predV ( x , y ) + predH ( x , y ) + W * H ) >> ( {log}_{2} W + {log}_{2} H + 1 ) \qquad ( 3 )$$

An index can be used to indicate the intra prediction modes, and the planar mode can be represented as index 0.

In ECM, two additional planar modes where only the horizontal interpolation or only the vertical interpolation are used to obtain the predicted samples for luma.

For planar horizontal mode, only the horizontal linear interpolation is performed based on the left reference sample and the top-right reference sample to predict the current sample as:

$$pred ( x , y ) = ( ( W - 1 - x ) * rec ( - 1 , y ) + ( x + 1 ) * rec ( W , - 1 ) + ( W >> 1 ) ) >> {log}_{2} ( W ) \qquad ( 4 )$$

For planar vertical mode, only the vertical linear interpolation is performed based on the above reference sample and the bottom-left reference sample to predict the current sample as:

$$pred ( x , y ) = ( ( H - 1 - y ) * r e c ( x , - 1 ) + ( y + 1 ) * r e c ( - 1 , H ) + ( H >> 1 ) ) >> {log}_{2} ( H ) \qquad ( 5 )$$

In the DC mode, an average value of the left and above reference samples to the current block is used for prediction generation. In HEVC, every intra-coded block has a square shape and the length of each of its side (i.e. left and above) is a power of 2. Thus, no division operations are required to calculate the average value. In VVC, blocks can have a rectangular shape that necessitates the use of a division operation per block in the general case. To avoid division operations for DC prediction, only the longer side is used to compute the average value for non-square blocks. And for square blocks reference samples from both left and above sides are used to compute the average value. The DC mode can be represented as index 1.

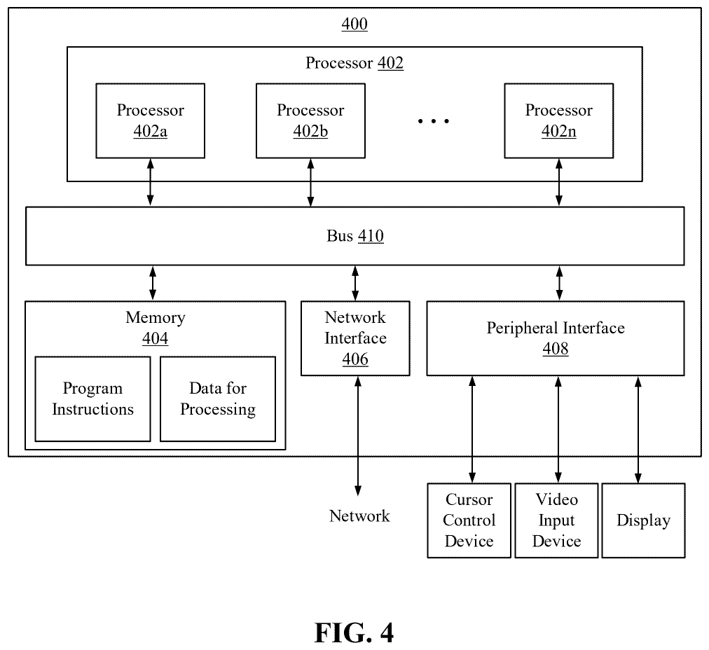

Angular intra prediction is a directional intra prediction method, which is extended from a prior implementation according to the HEVC standard. To capture the arbitrary edge directions presented in natural video, the VVC standard extends the number of angular intra prediction modes from 33 (as used in HEVC) to 65. FIG. 6 is a schematic diagram illustrating 67 exemplary intra prediction modes, according to some embodiments of the present disclosure. As shown in FIG. 6, the modes added in VVC are illustrated in broken lines. The 65 angle modes can be represented as index 2 to index 66 from bottom left to top right.

According to the VVC standard, to keep the complexity of the most probable mode (MPM) list generation low, an intra mode coding method with 6 MPMs is used by considering two available neighboring intra modes.

A unified 6-MPM list is used for intra blocks. The MPM list is constructed based on intra modes of the left and above adjacent block. Suppose the mode of the left is denoted as Left and the mode of the above block is denoted as Above, the unified MPM list is constructed as follows:
When an adjacent block is not available, its intra mode is set to Planar by default.
If both modes Left and Above are non-angular modes:

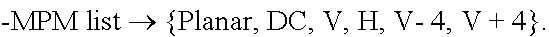

If one of modes Left and Above is angular mode, and the other is non-angular:
   Set a mode Max as the larger mode in Left and Above;

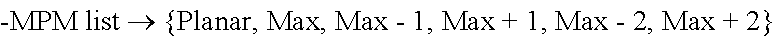

If Left and Above are both angular and they are different:
   Set a mode Max as the larger mode in Left and Above
   Set a mode Min as the smaller mode in Left and Above
   If Max-Min is equal to 1:

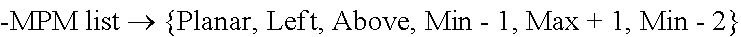

Otherwise, if Max-Min is greater than or equal to 62:

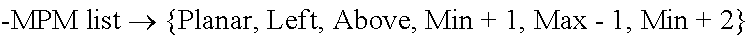

Otherwise, if Max-Min is equal to 2:

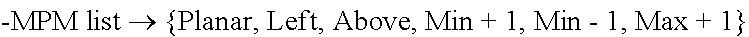

Otherwise:

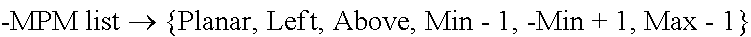

If Left and Above are both angular and they are the same:

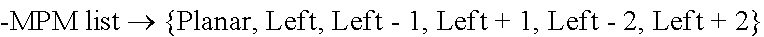

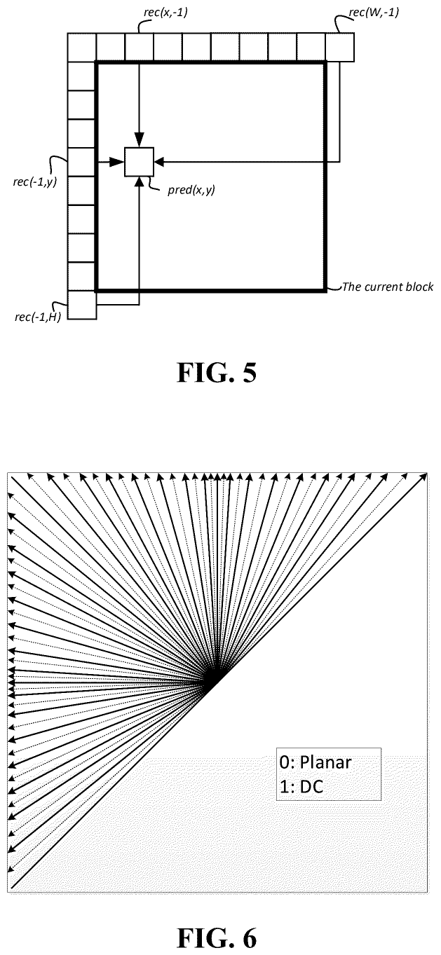

According to the ECM proposal, secondary MPM lists are introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. FIG. 7 is a schematic diagram illustrating adjacent blocks (L, A, BL, AR, AL) used in the derivation of a general most probable mode (MPM) list, according to some embodiments of the present disclosure. As shown in FIG. 7, the first entry in the general MPM list is the Planar mode. The remaining entries are composed of the intra modes of the left (L), above (A), below-left (BL), above-right (AR), and above-left (AL) adjacent blocks, and DIMD modes which are sorted in ascending order of sum of absolute difference (SAD) cost. Up to 5 modes with the smallest SAD cost are added. The SAD cost is computed between the prediction and the reconstruction samples of the template. The sorted directional modes with added offset are added into the general MPM list, and then the default modes, until the general MPM list with 22 entries is constructed.

If a block is vertically oriented, the order of neighboring blocks is A, L, BL, AR, AL; otherwise, it is L, A, BL, AR, AL.

According to the ECM proposal, the intra modes of the non-adjacent blocks can also be added to the MPM list. And the first MPM list except the planar mode is sorted by applying the intra prediction mode of each entry to a template of the current block and calculating the sum of absolute difference (SAD) values between predicted samples and reconstructed samples of the template.

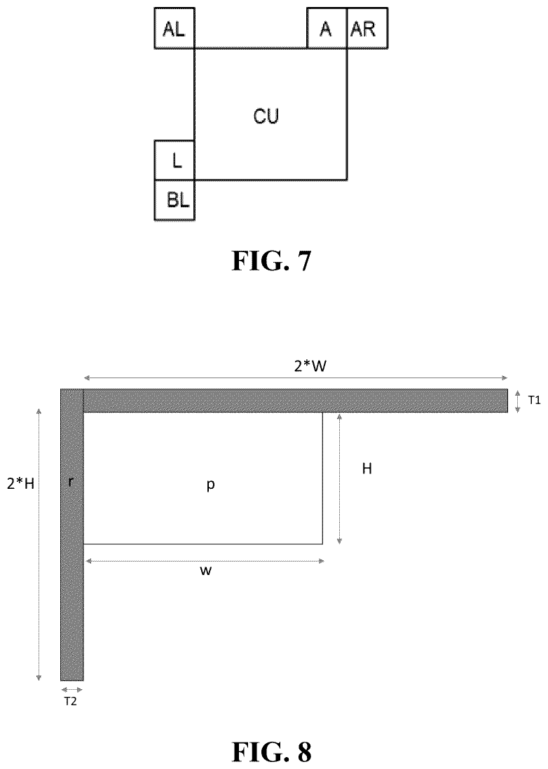

According to the ECM proposal, some of the conventional intra prediction modes (planar, DC and the 65 angular modes) may be replaced by matrix based intra prediction modes (also called PDP mode). In the matrix based intra prediction mode, a matrix of weights, which are defined for a block shape and intra mode index, is introduced. Those weights are multiplied by the neighbor reference template to derive the predicted values of the current block. FIG. 8 is a schematic diagram illustrating an exemplary L shaped neighborhood for a given predicted block, according to some embodiments of the present disclosure. As shown in FIG. 8, the weights are applied to the reference samples of the L shaped causal neighborhood template.

The reference samples in the causal neighborhood are denoted as r, and F (x, y) is the matrix of weights. Then the predicted value pred (x, y) can be derived as:

$$pred ( x , y ) = {\sum }_{k} F ( x , y , k ) * r ( k ) \qquad ( 6 )$$

where k denotes the index of the reference sample in the template.

The prediction is used for block size with both width and height up to 32 (except for 4×32, 32×4, 8×32, and 32×8). The template size is 2 for blocks with both width and height up to 16 and the modes with index 0, 1, and (2+2×k) are replaced. For other blocks, template size is set to 1 and the modes with index 0, 1, and (2+4×k) are replaced. The prediction is only performed for 16×16 positions, and the rest of the samples are generated by bilinear interpolation. For all block sizes, block shape and mode-based symmetry is used. Reference length is set to W and H for modes with index greater than 18 and less than 50 and set to 2×W and 2×H for other modes.

In ECM, a decoder side intra mode derivation (DIMD) mode is applied. When DIMD is applied, up to five intra modes are derived from the reconstructed neighbor samples, and those five predictors are combined with the non-directional predictor (planar or block vector—based predictor) with the weights derived from the histogram of gradients. The decision between for the non-directional modes is taken according to the template cost. Specifically, the block vectors of all adjacent and non-adjacent merge candidates (coded in IntraTMP or IBC) are compared to planar prediction on the reconstructed template. The template matching cost (TM cost) is used to select the best predictor among them. The TM cost is calculated using the sum of absolute differences (SAD) or the sum of absolute transformed differences (SATD).

For a block of size W×H, the weight for each of the five derived modes is modified if the one the above or left histogram magnitudes is twice larger than the other one. In this case, the weights are location dependent and computed as follows:

If the above histogram is twice the left, then:

$${w}_{i} ( x , y ) = {wDimd}_{i} + {Δ}_{i} - 2 {Δ}_{i} \frac{y}{( H - 1 )} \qquad ( 7 )$$

And if the left histogram is twice the above, then:

$${w}_{i} ( x , y ) = {wDimd}_{i} + {Δ}_{i} - 2 {Δ}_{i} \frac{x}{( W - 1 )} \qquad ( 8 )$$

where, in Equation 7 and Equation 8, wDimdᵢ is the unmodified uniform weight of the DIMD, Δᵢ is pre-defined and set to 10.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

Finally, the region of neighboring reconstructed samples used for computing the histogram of gradients is modified, depending on reconstructed samples availability. The region of decoded reference samples of current W×H luma CB is extended towards the above-right side if available, up to W additional columns. It is extended towards the bottom-left side if available, up to H additional rows.

Further, an extrapolation filter-based intra prediction (EIP) mode is described. In the EIP mode, the samples in a CU are predicted from the top-left position to the bottom-right position by applying an extrapolation filter to neighboring reconstructed samples or predicted samples. The EIP mode uses a 15-tap filter for prediction as below:

$${pred}_{( x , y )} = {\sum }_{i = 0}^{13} ( {c}_{i} \times {t}_{( x - offset {X}_{i} , y - offset {Y}_{i} )} ) + {c}_{14} \times {2}^{bitdepth - 1} \qquad ( 9 )$$

where pred (x,y) is the predicted value at position (x, y) in the CU, cᵢ is the filter coefficient, and the t(x−offsetX_{i,y}−offsetYᵢ) is the reconstructed samples or predicted samples. Predicted sample values are clipped to the range of the reference samples instead of the full sample value range. Reference sample area used for determining the range is the same that is used when generating the filter coefficients.

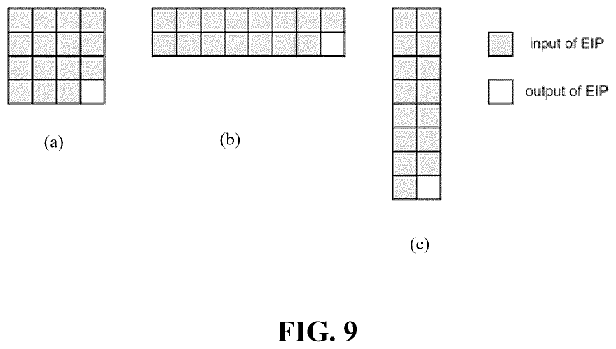

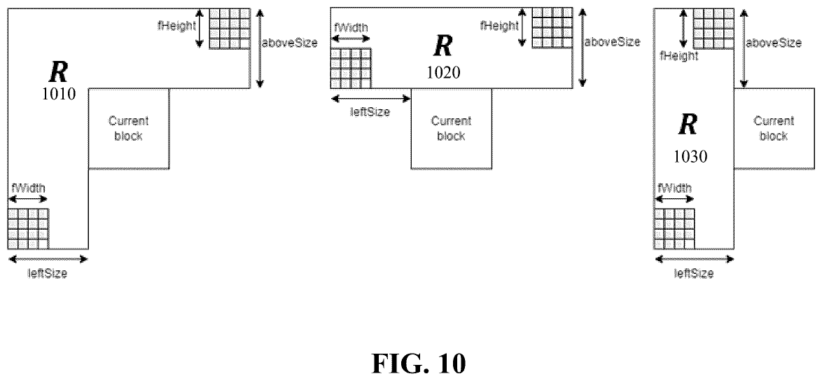

The EIP filter can be derived from the neighboring reconstructed samples or be inherited from the previous EIP coded blocks. FIG. 9 illustrates three exemplary EIP filter shapes, according to some embodiments of the present disclosure. As shown in FIG. 9, three example EIP filter shapes are illustrated respectively: a first EIP filter shape (a), a second filter shape (b), and a third filter shape (c). FIG. 10 illustrates three exemplary types of reference area R (also referred as reconstructed area) supported in ECM, according to some embodiments of the present disclosure.

In some embodiments, for a CU coded in the EIP mode, an EIP merge flag is signaled to indicate whether the EIP filter is inherited from previous blocks coded in EIP mode. When the EIP merge flag is true, an EIP merge list is constructed from the spatial adjacent, spatial non-adjacent, temporal and historical candidates. The position and inclusion order of these candidates are the same as those used in Cross-Component Prediction (CCP) merge candidate list. An EIP merge index is further signaled to indicate which EIP merge candidate is selected. The filter shape and the filter coefficients of the selected candidate are then inherited to code the CU.

When the EIP merge flag is false, the EIP filter is derived from the neighboring reconstructed samples, and the relevant syntax element is signaled to indicate which one of the three types of reference area R (1010, 1020, and 1030 shown in FIG. 10) and which one of the three filter shapes ((a), (b), and (c) shown in FIG. 9) are used for the CU. The selected filter moves in the selected reference area R either horizontally or vertically with a one-pixel step to construct the auto-correlation matrix and the cross-correlation vector. The calculation of coefficients from the auto-correlation matrix and the cross-correlation vector is similar to that of convolutional cross-component model (CCCM) with added L-2 regularization. The coefficients are computed as

$$\hat{β} = {( {A}^{T} A + λ I )}^{- 1} {A}^{T} y , \qquad ( 10 )$$

where λ is the regularization parameters. An L2-regularization is achieved by a diagonal matrix λI being added to the “A^{T}A” matrix.

A subset of the coefficients can be relaxed (unregularized). In this case, when the ith coefficient is relaxed, the (ith row, ith column) entry of the diagonal matrix λI is set to zero. In regularized EIP scheme:
λ=M·p_{EIP}, where p_{EIP}=15 is the number of filter taps in EIP.
   M=192 when the number of input samples nSamples≤2024, and thus λ=2880.
   otherwise M=128, and thus λ=1920.
The bias term of EIP is relaxed (unregularized): the bottom-right entry of the diagonal matrix is set to zero.

After generating the prediction samples of the CU using the EIP filter, an intra prediction mode is derived by applying the DIMD process to the prediction samples. Specifically, a horizontal gradient and a vertical gradient are calculated for each predicted sample to build a histogram of gradient. Then the intra prediction mode corresponding to the largest histogram count is used to determine the Low-Frequency Non-Separable Transform (LFNST), Non-Separable Primary Transform (NSPT), or Multiple Transform Selection (MTS) transform set.

Next, intra sub-partitions (ISPs) are described. The ISP technique divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It is noted that the M×128 (with M≤64) and 128×N (with N≤64) ISP blocks could generate a potential issue with the 64× 64 Virtual Pipeline Data Unit (DPDU). For example, an M×128 CU in the single tree case has an M×128 luma TB and two corresponding

$$\frac{M}{2} \times 64 chroma TBs .$$

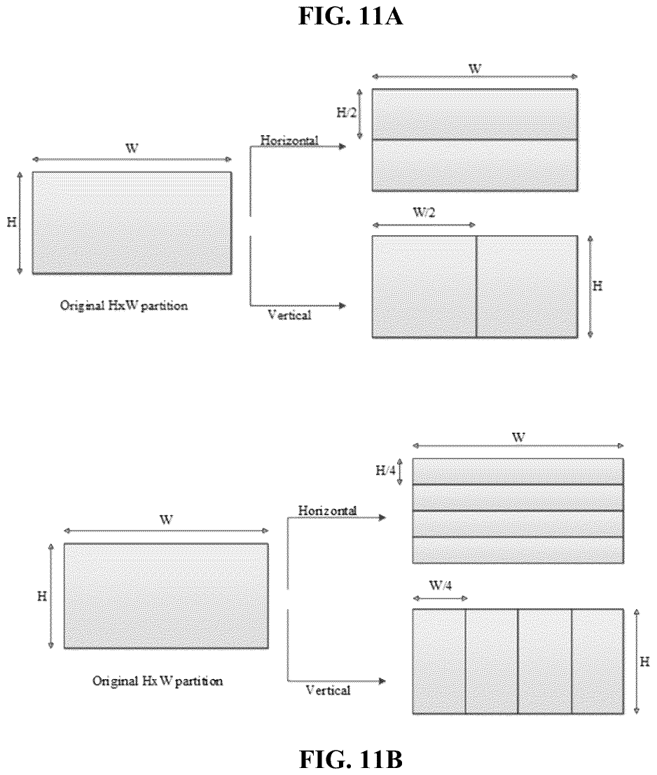

If the Cu uses ISP, then the luma TB will be divided into four M×32 TBs (only the horizontal split is possible), each of them being smaller than a 64×64 block. However, in the current design of ISP chroma blocks are not divided. Therefore, both chroma components of the two TBs will have a size greater than a 32× 32 block. Analogously, a similar situation could be created with a 128×N CU using ISP. Hence, these two cases are an issue for the 64× 64 decoder pipeline. For this reason, the CU sizes that can use ISP are restricted to a maximum of 64× 64. FIG. 11A and FIG. 11B illustrate examples of two possibilities of sub-partitions, respectively, according to some embodiments of the present disclosure. FIG. 11A illustrates an exemplary luma intra-predicted blocks vertically or horizontally into 2 sub-partitions. FIG. 11B illustrates an exemplary luma intra-predicted blocks vertically or horizontally into 4 sub-partitions. All sub-partitions fulfill the condition of having at least 16 samples.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions and each prediction region has a size 4×N and four transforms each having a size of 2×N are used. Also, a 4×N coding block that is coded using ISP with vertical split is predicted by using the full 4×N block, and four transformations each having a size 1×N are used. Although the transform sizes of 1×N and 2×N are allowed, it is asserted that the transformations of these blocks in 4×N regions can be performed in parallel. For example, when a 4×N prediction region contains four 1×N transforms, there is no transformation in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, comparing processing 4×4 regular-coded intra blocks, there is no delay added in processing these smaller blocks.

For each sub-partition, reconstructed samples are obtained by adding the residual signal to the prediction signal. A residual signal is generated by processes such as entropy decoding, inverse quantization, and inverse transformation. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. Summary of interaction of ISP with other coding tools are further described below.

Multiple Reference Line (MRL): if a block has an MRL index other than 0, then the ISP coding mode will be inferred to be 0 and therefore ISP mode information will not be sent to the decoder.

Entropy coding coefficient group size: the sizes of the entropy coding subblocks have been modified so that they have 16 samples in all possible cases, as shown in Table 1. Note that the new sizes only affect blocks produced by ISP in which one of the dimensions is less than 4 samples. In all other cases coefficient groups keep the 4×4 dimensions.

TABLE 1
Entropy coding coefficient group size

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

Coded block flag (CBF) coding: it is assumed to have at least one of the sub-partitions has a non-zero CBF. Hence, if n is the number of sub-partitions and the first n-1 sub-partitions have produced a zero CBF, then the CBF of the n-th sub-partition is inferred to be 1.

Transform size restriction: all ISP transforms with a length larger than 16 points uses the DCT-II.

Multiple Transform Selection (MTS) flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according to the intra mode, the processing order, and the block size utilized. Hence, no signaling is required. For example, let ty and ty be the horizontal and the vertical transforms selected respectively for the w×h sub-partition, where w is the width and h is the height. Then the transformation is selected according to the following rules:
If w=1 or h=1, then there is no horizontal or vertical transformation respectively;
If w≥4 and w≤16, t_{H}=DST-VII, otherwise, t_{H}=DCT-II; and
If h≥4 and h≤16, t_{V}=DST-VII, otherwise, t_{V}=DCT-II.

In the ISP mode, all 67 intra modes are allowed. Position Dependent Prediction Combination (PDPC) is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

It is observed that the above-described intra prediction techniques may have the following problems.

For the EIP mode in current ECM, the predictor is generated by an extrapolation filter instead of the conventional intra prediction mode. The absence of conventional intra prediction signals could potentially constrain the performance of the EIP mode.

Moreover, the prediction of the EIP mode is performed in an auto-regression manner, in which the EIP mode generates prediction values for the current block from the top-left position to the bottom-right position by a diagonal prediction order. The prediction error will propagate backwards along with the prediction order, leading to a deterioration of the prediction results.

The present disclosure provides methods to solve some or all of the above-described problems.

In the present disclosure, some modifications of the EIP coding process are proposed to improve coding efficiency and alleviate the error propagation problem in the EIP prediction process.

Embodiments of the present disclosure propose an EIP fusion mode. In the current EIP mode, the EIP predictor generated by the derived extrapolation filter is taken as the final prediction signal for the EIP coding block. To enhance the prediction results, traditional intra prediction modes (including planar, DC, angular prediction modes) are proposed to fuse with the EIP predictor to provide better prediction results.

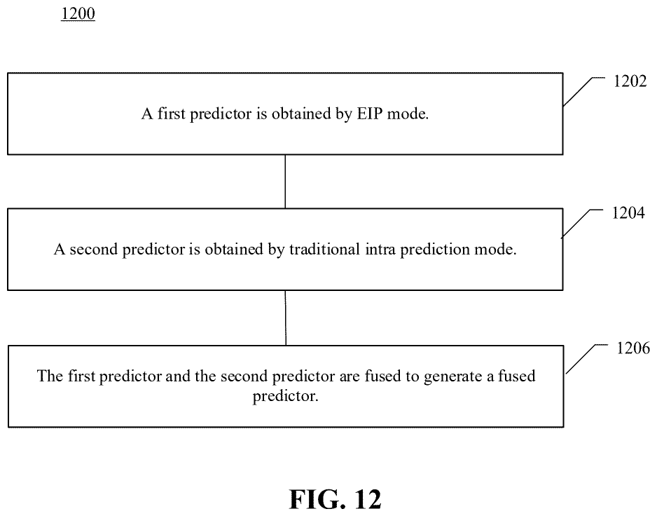

FIG. 12 is a flowchart of an exemplary method of extrapolation filter-based intra prediction (EIP) fusion mode, according to some embodiments of the present disclosure. Method 1200 can be performed by an encoder (e.g., by process 200A of FIG. 2A or 200B of FIG. 2B), performed by a decoder (e.g., by process 300A of FIG. 3A or 300B of FIG. 3B), or performed by one or more software or hardware components of an apparatus (e.g., apparatus 400 of FIG. 4). For example, a processor (e.g., processor 402 of FIG. 4) can perform method 1200. In some embodiments, method 1200 can be implemented by a computer program product, embodied in a computer-readable medium, including computer-executable instructions, such as program code, executed by computers (e.g., apparatus 400 of FIG. 4). Referring to FIG. 12, method 1200 may include the following steps 1202 to 1208.

At step 1202, a first predictor is obtained by EIP mode.

At step 1204, a second predictor is obtained by traditional intra prediction mode. The traditional intra prediction mode includes a planar mode, a DC mode, and intra angular modes. In some embodiments, an intra angular predictor is derived by a DIMD process with neighboring reconstructed samples. The intra angular predictor with highest HoG amplitude is selected. In some embodiments, a flag is signaled to indicate whether the planar mode, the DC mode, or an intra angular mode is selected for fusing with EIP mode.

At step 1206, the first predictor and the second predictor are fused to generate a fused predictor. The first predictor and the second predictor are fused based on a fusion weight, and the weight value is a fractional number, and the weight value can be positive or negative. For example, the fused predictor is generated as follows:

$${Pred}_{final} = {Pred}_{EIP} \times {w}_{0} + {Pred}_{conventional} \times ( 1 - {w}_{0} ) , \qquad ( 11 )$$

where the Pred_{final} is the fused prediction after fusion. The Pred_{EIP} and Pred_{conventional} are the predictor generated by EIP mode and traditional intra prediction modes (for example, planner mode, intra angular mode, etc.), respectively. w₀ is the fusion weight applied to EIP predictor, and w₀ is a fractional number.

In some embodiments, the value of w₀ can be one of {1/8, 2/8, 3/8, 4/8, 5/8, 6/8, 7/8}. In some embodiments, the value of w₀ can be one of {1/16, 2/16, 3/16, 4/16, 5/16, 6/16, 7/16, 8/16, 9/16, 10/16, 11/16, 12/16, 13/16, 14/16, 15/16}. In some embodiments, the value of Wo can be one of {4/8, 5/8, 6/8, 7/8}. In some embodiments, the value of w₀ is fixed to 6/8.

In some embodiments, the value of w₀ is a negative fractional number such as −½. In some embodiments, the value of w₀ can be one of {-4/8, 1/8, 2/8, 3/8, 4/8, 5/8, 6/8, 7/8}.

At step 1208, prediction is performed using the fused predictor. For example, for an encoding process, one or more pictures are predicted based on the fused predictor. For decoding process, one or more pictures are reconstructed based on the fused predictor.

In some embodiments, fusion flag signaling can be used. Specifically, whether to apply fusion to the EIP mode can be explicitly signaled or implicitly derived by template matching cost (TM cost).

In some embodiments, whether to perform the EIP fusion mode is signaled as a sub-mode of the current EIP prediction mode. Specifically, before step 1204, a flag is signaled to indicate whether to fuse the EIP predictor and the conventional intra predictor as the final EIP fusion predictor. For example, if the flag indicating the fusing prediction mode is applied, steps 1204 and 1206 are performed. If the flag indicating the fusing prediction mode is not applied, steps 1204 and 1206 are skipped, and the first predictor (i.e., EIP predictor) is used for prediction.

In some embodiments, whether to perform the EIP fusion mode is determined based on a block size of a CU. In some embodiments, the EIP fusion mode does not applied on some larger blocks, for example, a block has a width w and a height h, and the block size is denoted as w× h. The EIP fusion mode is disabled if the block size is equal to or greater than a threshold. In some embodiments, the threshold is between 128 and 1024. In some embodiments, when one of the width or the height is equal to or greater than 32, for example, for a block size being 32×32, 32×64, or 64×32, it is determined that the EIP fusion mode is disabled.

In some embodiments, a template-based EIP fusion prediction mode is further proposed. In the template-based EIP fusion mode, whether to perform the EIP fusion mode is determined based on TM costs to constitute a template-based EIP fusion predictor without signaling overhead. For example, in the EIP mode, for each EIP predictor candidate, the TM cost is used to determine whether to fuse the EIP predictor and the conventional intra predictor. In some embodiments, the conventional intra predictor is derived from the DIMD process.

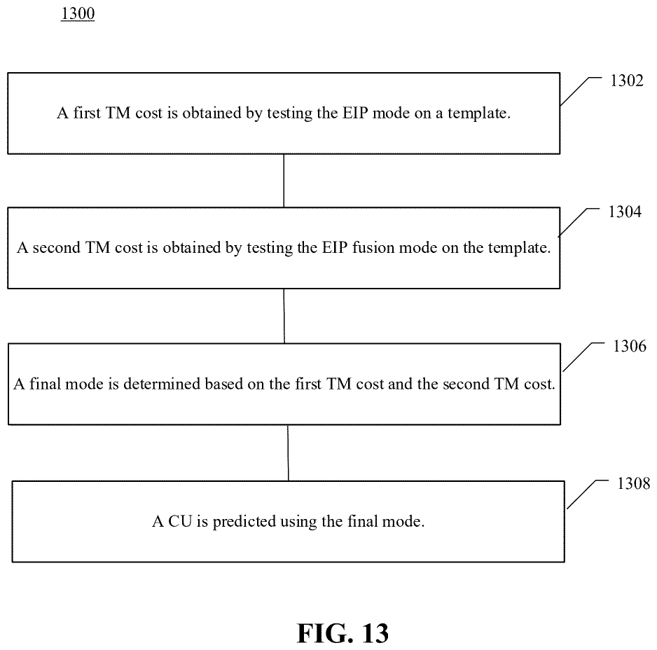

FIG. 13 is a flowchart of another exemplary method for EIP fusion mode, according to some embodiments of the present disclosure. Method 1300 can be performed by an encoder (e.g., by process 200A of FIG. 2A or 200B of FIG. 2B), performed by a decoder (e.g., by process 300A of FIG. 3A or 300B of FIG. 3B), or performed by one or more software or hardware components of an apparatus (e.g., apparatus 400 of FIG. 4). For example, a processor (e.g., processor 402 of FIG. 4) can perform method 1300. In some embodiments, method 1300 can be implemented by a computer program product, embodied in a computer-readable medium, including computer-executable instructions, such as program code, executed by computers (e.g., apparatus 400 of FIG. 4). Referring to FIG. 13, method 1300 may include the following steps 1302 to 1306.

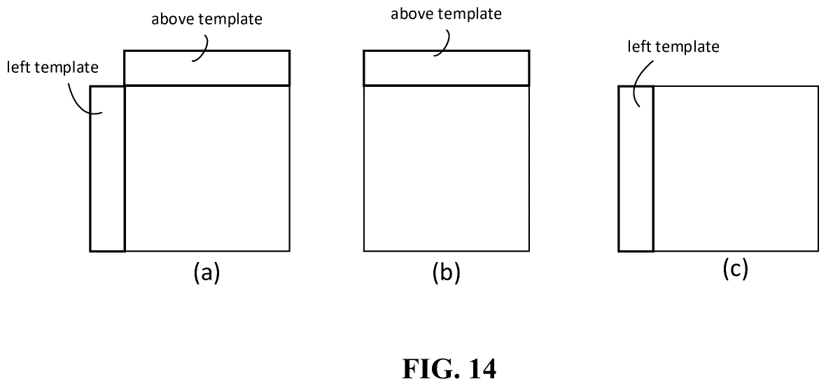

At step 1302, a first TM cost is obtained by testing the EIP mode on a template. FIGS. 12A-12C illustrates different templates for EIP fusion mode respectively, according to some embodiments of the present disclosure. FIG. 14 illustrates three exemplary template types, according to some embodiments of the present disclosure. As shown in FIG. 14, three templates include LEFT_ABOVE_TEMPLATE (a), ABOVE_TEMPLATE (b), and LEFT_TEMPLATE (c). The width and the height of the template are both positive integers, such as 4. The TM cost is calculated using the sum of absolute differences (SAD) or the sum of absolute transformed differences (SATD).

At step 1304, a second TM cost is obtained by testing the EIP fusion mode on the template. The templates can also refer to FIG. 14.

As step 1306, a final mode is determined based on the first TM cost and the second TM cost. In some embodiments, the final mode is the prediction mode that has the smaller TM cost. For example, if the first TM cost is smaller than or equal to the second TM cost, the EIP mode is determined to be final mode. If the second TM cost is smaller than the first TM cost, the fusion EIP mode is determined to be final mode.

At step 1308, A CU is predicted using the final mode.

In some embodiments, the template-based EIP fusion prediction mode is only tested for partial EIP prediction candidates but not for all candidates. For example, after the best N (a positive integer) candidates are derived for EIP mode, the template-based EIP fusion prediction mode is performed only for the best N candidates. That is, TM cost of EIP mode and TM cost of EIP fusion mode are obtained for the best N candidates, and a final mode is determined for the N candidates. The best N candidates, for example N can be 3 or 6, can be obtained by sorting the TM costs for all the EIP prediction candidates in an ascending order and selecting the first N candidates as the best N candidates. For other EIP prediction candidates, the EIP mode is always applied.

In some embodiments, fusion weight signaling can be used. For example, the fusion weight can be explicitly signaled or implicitly derived.

In some embodiments, a fusion weight index is signaled when the fusion EIP mode is applied. In some embodiments, more than one fusion weight are allowed. For example, different values of the fusion weight index indicate different fusion weights, the different fusion weights can be selected from a fusion weight set.

In some embodiments, the fusion weight is derived based on the TM cost. For each of the EIP fusion prediction candidate, the best EIP fusion weight is determined from a set of optional weights, such as {4/8, 5/8, 6/8, 7/8}, based on the TM cost.

In some embodiments, the fusion weight is directly set according to TM cost as follows:

$${w}_{0} = \frac{{TMCost}_{EIP}}{{TMCost}_{EIP} + {TMCost}_{conventional}} , \qquad ( 12 )$$

where TMCost_{EIP} is the sum of absolute different between predictor generated by EIP mode and neighboring reconstructed samples, TMCost_{conventional} is the sum of absolute different between predictor generated conventional intra prediction and neighboring reconstructed samples.

In some embodiments, the fusion flag and the fusion weight index are signaled in the bitstream.

In some embodiments, for each of the EIP prediction candidates, a fusion flag is signaled to indicate whether to apply the EIP fusion mode. If the EIP fusion mode is selected, the fusion weight index is signaled. For example, the fusion weight can be selected from several candidates including {1/8, 2/8, 3/8, 4/8, 5/8, 6/8, 7/8}.

In some embodiments, the fusion weight of the EIP predictor is fixed, such as 6/8. The signaling of fusion weight index can be skipped.

In some embodiments, whether to perform the EIP fusion mode and the fusion weight are determined based on the TM cost. For example, if the number of original EIP candidates is N, where N is a positive integer, each of the candidates has M (a positive integer) fusion weights options. A first plurality of TM costs are obtained for each prediction candidate for EIP mode, i.e., EIP prediction candidate. A second plurality of TM costs are obtained for each prediction candidate for EIP fusion mode, i.e., EIP fusion prediction candidate. Each EIP fusion prediction candidate is obtained based on an EIP prediction candidate and a fusion weight. Then, together with the EIP prediction candidates and the EIP fusion prediction candidates, a total of (M+1)×N candidates are sorted based on the TM costs in an ascending order and the candidate with the smallest TM cost is selected as the final candidate to perform the prediction. For example, if the selected candidate is from the original EIP candidate, then the EIP mode is used for prediction with the selected candidate. If the selected candidate is from the EIP fusion mode candidates, then the EIP fusion mode is used for prediction with the selected candidate (including the fusion weight).

In some embodiments, the proposed EIP fusion mode can be combined with the EIP merge mode.

In some embodiments, in EIP merge mode, the current block may inherit one or more candidates from neighboring blocks. The fusion flag indicating whether to perform the EIP fusion mode and the fusion weight index indicating the fusion weight for the current block can be inherited from the merge candidates in the EIP merge mode.

Embodiments of the present disclosure provide methods for performing EIP on sub-partitions. In the current EIP mode, a 15-tap extrapolation filter is derived from the template regions and applied to the whole block. For samples located at a considerable distance from the reconstructed samples, the input samples for the extrapolation filter may consist entirely of prediction samples without including any reconstructed samples, thereby potentially leading to inaccurate prediction results.

In some embodiments, it is proposed to apply the EIP prediction process on each sub-partition of the current block. The shape of the sub-partition is implicitly determined.

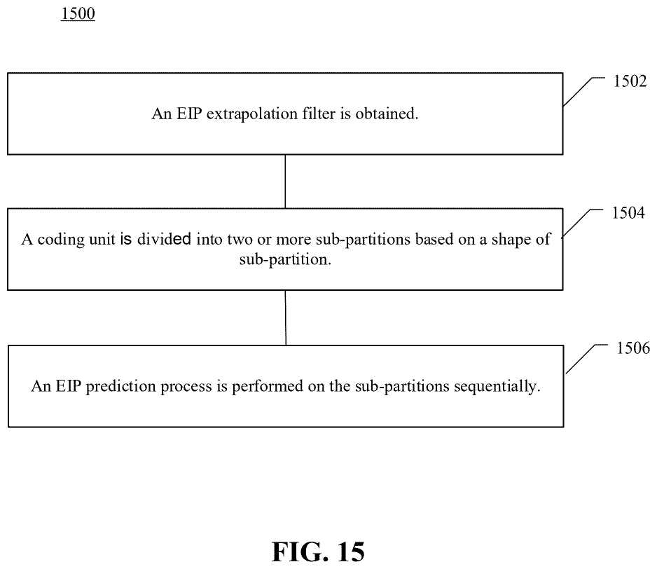

FIG. 15 is a flowchart of an exemplary method for performing extrapolation filter-based intra prediction (EIP) on sub-partitions, according to some embodiments of the present disclosure. Method 1500 can be performed by an encoder (e.g., by process 200A of FIG. 2A or 200B of FIG. 2B), performed by a decoder (e.g., by process 300A of FIG. 3A or 300B of FIG. 3B), or performed by one or more software or hardware components of an apparatus (e.g., apparatus 400 of FIG. 4). For example, a processor (e.g., processor 402 of FIG. 4) can perform method 1500. In some embodiments, method 1500 can be implemented by a computer program product, embodied in a computer-readable medium, including computer-executable instructions, such as program code, executed by computers (e.g., apparatus 400 of FIG. 4). Referring to FIG. 15, method 1500 may include the following steps 1502 to 1506.

At step 1502, an EIP extrapolation filter is obtained. In some embodiments, the EIP extrapolation filter is derived from the template regions. In some embodiments, the EIP extrapolation filter is inherited from blocks in an EIP merge list.

At step 1504, a coding unit is divided into two or more sub-partitions based on a shape of sub-partition. In some embodiments, a coding block is horizontally split into two or more sub-partitions. In some embodiments, a coding block is vertically split into two or more sub-partitions. In some embodiments, a coding block is evenly split into two or more sub-partitions. In some embodiments, a coding block is unevenly split into two or more sub-partitions.

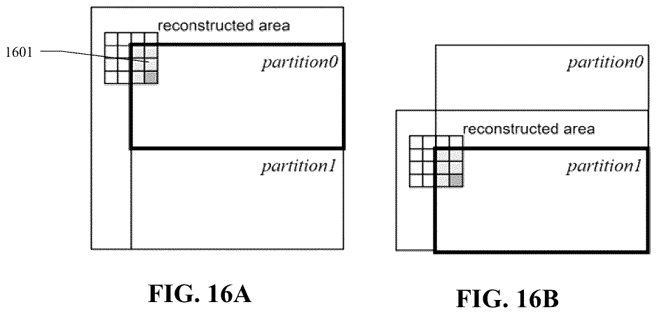

At step 1506, an EIP prediction process is performed on the sub-partitions sequentially. For example, the coding block is horizontally split into two sub-partitions. FIG. 16A and FIG. 16B illustrate exemplary processes of performing EIP prediction on two sub-partitions respectively, according to some embodiments of the present disclosure. The reconstruction samples of the encoded sub-partitions (e.g., partition 0) can be used as reference samples for the next sub-partition (e.g., partition 1). Referring to FIG. 16A, a first sub-partition (denotes as partition 0) is predicted by using the EIP extrapolation filter and the reconstruction samples 1601 are obtained. Referring to FIG. 16B, when encoding a second partition (denotes as partition 1), the reconstruction samples from partition 0 can be used as the input of EIP extrapolation filter for the prediction of partition 1. In some embodiments, the shape of the sub-partitions is implicitly determined by the template type, filter shape, and the block size. The shape of the sub-partitions includes a sub-partition direction and a number sub-partitions. Specifically, the split direction of the sub-partition can be determined based on Table 2 and the divided sub-partitions have the same shape. The number of the sub-partitions N is a positive integer, for example 2. In some embodiments, the number of the sub-partitions N can be greater than 2.

TABLE 2
Sub-partition direction of the EIP sub-partition mode

| | Filter shape(a) | Filter shape(b) | Filter shape(c) |
|---|---|---|---|
| Template type(a) | No split | Vertical | Horizontal |
| Template type(b) | Horizontal | Horizontal | Horizontal |
| Template type(c) | Vertical | Vertical | Vertical |

where filter shapes can refer to filter shapes (a), (b), (c) in FIG. 9, and template type can refer to template types (a), (b), (c) in FIG. 10.

In some embodiments, the number of sub-partitions N is determined based on the block size. For example, for vertical split, N equals to 1 if the block width is less than 2 times of the block height, N equals to 4 if the block width is more than 2 times of the block height, otherwise the N equals to 2. For horizontal split, N equals to 1 if the block height is less than 2 times of the block width, N equals to 4 if the block height is more than 2 times of the block width, otherwise the N equals to 2.

In some embodiments, EIP prediction is applied at a sub-partition level for EIP merge block. In some embodiments, an extrapolation filter of the EIP merge block inherits the extrapolation filter from blocks in the EIP merge list. After the EIP extrapolation filter is determined, the shape of the sub-partition can be implicitly determined for the current block using rules designed as described above.

In some embodiments, the EIP merge block inherits the extrapolation filter from the block in the EIP merge list. The shape of sub-partition is inherited from the block in the EIP merge list, where the block in the EIP merge list uses rules designed as described above.

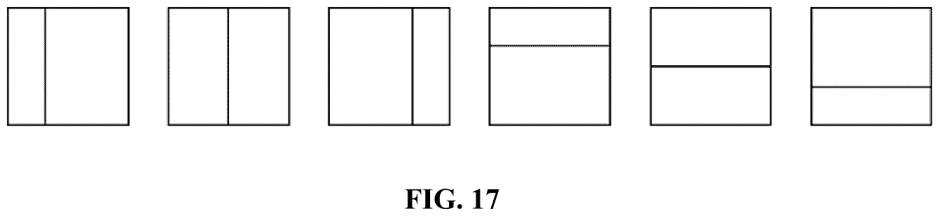

In some embodiments, whether to perform the EIP prediction at a sub-partition level is explicitly signaled. For example, a flag indicating whether the two or more sub-partitions are enabled. If the sub-partitions are enabled, the shape of the sub-partitions is determined based on the same rule designed as described above. In some embodiments, the shape of the sub-partitions is explicitly signalled. For example, a first flag is signalled to indicate whether the two or more sub-partitions are enabled, and a second flag is signalled to indicate a sub-partition direction of the shape of sub-partition. In some embodiments, the shape of the sub-partitions is explicitly signalled using more than two flags. For example, a first flag is signalled to indicate whether the two or more sub-partitions are enabled, a second flag is signalled to indicate a sub-partition direction of the shape of sub-partition, and a third index is signalled to indicate the number of the sub-partitions. In some embodiments, the shape of the sub-partitions is explicitly signalled by an index. For example, a flag is signalled to indicate whether the two or more sub-partitions are enabled, and an index is signalled to indicate the shape of sub-partition. FIG. 17 illustrates exemplary different shapes of sub-partition, according to some embodiments of the present disclosure. The shape candidates of sub-partition can refer to FIG. 11A, FIG. 11B, and FIG. 17.

In some embodiments, explicitly signalling the shape of the sub-partitions can be applied on both the EIP block and EIP merge block.

In some embodiments, performing EIP for sub-partitions with updated EIP extrapolation filter can be used.

In current ECM, the initial extrapolation filter is derived from the template regions. With the EIP extrapolation filter coefficients β, the prediction sample by applying EIP extrapolation filter can be expressed as the following equation:

$${q}^{′} = {\sum }_{{p}_{i} ∈ W} {p}_{i} \times {β}_{i} , \qquad ( 13 )$$

where q′ is the predicted output sample for q, pᵢ are the input samples, and W denotes the area of the input samples. The error between the predicted output sample q′ and the sample q is:

$$err = {q}^{′} - q . \qquad ( 14 )$$

The filter coefficients are calculated by minimizing Mean Squared Error (MSE) between all of the predicted and reconstructed samples in a reference area R:

$$β = arg min E ( {err}^{2} ) . \qquad ( 15 )$$

The MSE minimization is performed by calculating autocorrelation matrix for the input and a cross-correlation vector between the input and output. Autocorrelation matrix is LDL decomposed and the final filter coefficients are calculated using back-substitution. And the optimal solution \hat{β} can be obtained by Equation (10) in current ECM design.

Embodiments of the present disclosure provide an EIP sub-partitions extension method, in which reconstructed samples closer to the sub-partitions can be used to update the initial extrapolation filter for coding performance improvement. For example, adjacent reconstructed samples obtained from the previous encoded sub-partition can be included in an updated reference area R′ to recalculate the updated filter coefficients \hat{β}′.

In some embodiments, the extrapolation filter is updated using neighboring reconstructed samples for each sub-partition.

In some embodiments, for a first sub-partition, the initial EIP extrapolation filter obtained at CU level is applied. For the remaining sub-partitions, the extrapolation filter is updated by taking the reconstruction samples from the previous encoded sub-partitions into Equation (10) for EIP extrapolation filter coefficients calculation. For example, the reference area R is extended to include the reconstruction samples from all the previous encoded sub-partitions and updated reconstruction samples and updated reference area are obtained.

In some embodiments, the reference area R is extended to only include the reconstruction samples from the last previous encoded sub-partition for EIP filter coefficients updates.

In some embodiments, the total number of samples inside the reference area R remains unchanged, while the N farthest samples from the current sub-partition are replaced by the constructed samples from the previous encoded sub-partitions for computational complexity reduction, where the number of constructed samples is N.

In some embodiments, the predicted sample values are clipped to the range of reference samples instead of the full sample value range. When the reference area is changed during the EIP extrapolation filter updating, the clip range of the reference samples is also updated by calculate the minimum and maximum of the sample values in the updated reference area.

In some embodiments, whether to update the EIP extrapolation filter is adaptively determined. For example, if the current block uses the EIP mode with sub-partitions, a flag is signalled to indicate whether to update the EIP extrapolation filter coefficients.

In some embodiments, whether to use the updated the EIP extrapolation filter is determined based on TM cost. For example, a first TM cost is obtained by applying the initial EIP extrapolation filter on a template region and a second TM cost is obtained by applying the updated EIP extrapolation filter on the template region at the block level. The first TM cost and the second TM cost are compared and if the second TM cost being smaller than the first TM cost, the updated EIP extrapolation filter is determined to be used for the current sub-partition. Otherwise, the initial EIP extrapolation filter is used.

In some embodiments, it is proposed to update the EIP extrapolation filter inherited from an EIP merge list, and the inherited merge block is an EIP block using sub-partition. In some embodiments, the inherited filter is updated on the merge block using the reconstruction samples. In some embodiments, the inherit filter is updated on the merge block using the reconstruction samples of the merge block, and the merge block uses the updated EIP extrapolation filter.

In some embodiments, the initial extrapolation filter inherited from the merge block, the updated extrapolation filter inherited from the merge block, the initial extrapolation filter derived from the current block, and the updated extrapolation filter derived from the current block are put together to determine the final extrapolation filter to be the extrapolation filter having the smallest TM cost.

In some embodiments, EIP fusion mode with sub-partitions can be used. The sub-partitions can be applied to extend the EIP fusion mode further improve the coding efficiency.

In some embodiments, at least one of the EIP predictor or the conventional intra predictor is generated at the sub-partition level and the fused predictor is generated at the sub-partition level or at the block level.

In some embodiments, either the EIP predictor or the conventional intra predictor is generated at the sub-partition level and the fused predictor at the sub-partition level is obtained by fusing the EIP predictor and the conventional intra predictor. Then, the final predictor at block level is formed by concatenating multiple fused sub-partition level sub-partitions. In some embodiments, both the EIP predictor and the conventional intra predictor are generated on the sub-partitions one by one separately. The EIP predictor and conventional intra predictor at block level are formed by concatenating their multiple sub-partition level predictors respectively. And then the final predictor at the block level is formed by fusing the EIP predictor and the conventional intra predictor at the block level. In some embodiments, the transform kernels of EIP mode and the conventional intra mode are independent. For example, the transform kernels are different. In some embodiments, the transform kernels of EIP mode and the conventional intra mode are the same.

In some embodiments, both the EIP predictor and the conventional intra predictor are generated for each sub-partition and the fused predictor is obtained by fusing the EIP predictor and the conventional intra predictor at the sub-partition level. A same transform kernel is used for both the EIP prediction and the conventional intra prediction.

In some embodiments, the EIP predictor is generated at the block level and the conventional intra predictor is generated at the sub-partition level. The fusion process is performed at the whole block level or at the sub-partition level to obtain the fused predictor.

In some embodiments, the EIP predictor is generated at the sub-partition level while the conventional intra predictor is generated at the whole block level. The fusion process is performed at the whole block level or at the sub-partition level to obtain the fused predictor.

The embodiments described in the present disclosure can be freely combined.

In some embodiments, a non-transitory computer readable medium storing a bitstream is provided. The bitstream is generated by receiving a video sequence and encoding the video sequence to generate coded information included in the bitstream. The bitstream can be transmitted to a decoder for decoding. The video sequence is encoded by the above-described methods.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

The embodiments may further be described using the following clauses:
1. A method of encoding a video sequence, the method comprising:
receiving a video sequence;
encoding the video sequence using an extrapolation filter-based intra prediction (EIP) fusion mode, wherein encoding the video sequence using the EIP fusion mode comprises:
   obtaining a first predictor by an extrapolation filter-based intra prediction (EIP) mode;
   obtaining a second predictor by an intra prediction mode;
   generating a fused predictor by fusing the first predictor and the second predictor; and
   predicting one or more pictures using the fused predictor.
2. The method according to clause 1, wherein generating the fused predictor by fusing the first predictor and the second predictor further comprises:
   weighted combining the first predictor and the second predictor using a fusion weight.
3. The method according to clause 2, wherein the fusion weight is selected from at least one set of:
{1/8, 2/8, 3/8, 4/8, 5/8, 6/8, 7/8};
{1/16, 2/16, 3/16, 4/16, 5/16, 6/16, 7/16, 8/16, 9/16, 10/16, 11/16, 12/16, 13/16, 14/16, 15/16};
{4/8, 5/8, 6/8, 7/8}; or {-4/8, 1/8, 2/8, 3/8, 4/8, 5/8, 6/8, 7/8}.
4. The method according to clause 2, wherein the fusion weight is 6/8 or −1/2.
5. The method according to clause 2, wherein the encoding further comprises:
encoding a fusion weight index indicating the fusion weight.
6. The method according to clause 2, wherein the encoding further comprises:
determining the fusion weight based on a template matching cost.
7. The method according to clause 1, wherein the encoding further comprises:
encoding a fusion flag indicating whether to use the EIP fusion mode.
8. The method according to clause 7, wherein the fusion flag is encoded for each EIP prediction candidate respectively.
9. The method according to clause 1, wherein the encoding further comprises:
determining whether to use the EIP fusion mode based on a block size of a coding unit (CU).
10. The method according to clause 1, wherein the encoding further comprises:
determining whether to use the EIP fusion mode based on template matching (TM) costs.
11. The method according to clause 10, wherein determining whether to use the EIP fusion mode based on the TM costs further comprises:
obtaining a first TM cost by testing the EIP mode on a template;
obtaining a second TM cost by testing the EIP fusion mode on the template; and
determining to use the EIP fusion mode when the second TM cost is smaller than the first TM cost.
12. The method according to clause 11, wherein the EIP fusion mode is tested on partial EIP prediction candidates.
13. The method according to clause 10, wherein determining whether to use the EIP fusion mode based on the TM costs further comprises:
obtaining a plurality of first TM costs, each first TM cost corresponding to an EIP prediction candidate;
obtaining a plurality of second TM costs, each second TM cost corresponding to a EIP fusion prediction candidate, wherein the EIP fusion prediction candidate is obtained based on an EIP prediction candidate and a fusion weight;
sorting the plurality of first TM costs and the plurality of second TM costs in an ascending order; and
selecting a prediction candidate with the smallest TM cost to be a final prediction candidate.
14. The method according to clause 2, wherein the encoding further comprises:
encoding a fusion flag indicating whether to use the EIP fusion mode; and
encoding a fusion weight index indicating the fusion weight; wherein the fusion flag and the fusion weight index are inherited from merge candidates in an EIP merge mode.
15. The method according to clause 1, wherein the encoding further comprises:
dividing a coding unit into two or more sub-partitions based on a shape of sub-partition; and
performing EIP prediction process on the two or more sub-partitions sequentially.
16. The method according to clause 15, wherein at least one of the first predictor and the second predictor is obtained at a sub-partition level, and the fused predictor is generated at the sub-partition level or a block level.
17. The method according to clause 16, wherein transform kernels of the EIP mode and the intra prediction mode are independent.
18. The method according to clause 16, wherein transform kernels of the EIP mode and the intra prediction mode are the same.
19. The method according to clause 1, wherein the intra prediction mode comprises at least one of a planar mode, an angular mode, and a DC mode.
20. The method according to clause 19, wherein the intra prediction mode is the angular mode, and the second predictor is derived by a Decoder-side Intra Mode Derivation (DIMD) mode with neighboring reconstructed samples.
21. The method according to clause 20, wherein the second predictor is a predictor with highest histogram of gradient (HoG) amplitude.
22. A method of encoding a video sequence, the method comprising:
receiving a video sequence;
encoding the video sequence by:
   dividing a coding unit into two or more sub-partitions based on a shape of sub-partition; and
   performing extrapolation filter-based intra prediction (EIP) process on the two or more sub-partitions sequentially.
23. The method according to clause 22, wherein the encoding further comprises:
   deriving an EIP extrapolation filter from template regions;
   predicting a first partition of the two or more sub-partitions using the EIP extrapolation filter to obtain first constructed samples;
   taking the first constructed samples as reference samples for a second partition of the two or more sub-partitions; and
   predicting the second partition based on the first constructed samples using the EIP extrapolation filter.
24. The method according to clause 22, wherein the EIP extrapolation filter is inherited from blocks in an EIP merge list.
25. The method according to clause 24, wherein the shape of sub-partition is inherited from the blocks in the EIP merge list.
26. The method according to clause 24, wherein the shape of sub-partition is determined based on a filter shape, a template type, and a block size of the coding unit.
27. The method according to clause 22, wherein the shape of sub-partition is determined based on a filter shape, a template type, and a block size of the coding unit.
28. The method according to clause 27, wherein the shape of sub-partition comprises a sub-partition direction and a number of sub-partitions, the sub-partition direction is determined based on the filter shape and the template type, and the number of sub-partitions is determined based on the block size.
29. The method according to clause 22, wherein the encoding further comprises:
encoding a first flag indicating whether the two or more sub-partitions are enabled.
30. The method according to clause 29, wherein the shape of sub-partition comprises a sub-partition direction and a number of sub-partitions and the encoding further comprises:
in response to the first flag indicating the two or more sub-partitions are enabled, encoding a second flag indicating the sub-partition direction of the shape of sub-partition.
31. The method according to clause 30, wherein the encoding further comprises:
encoding an index indicating the number of sub-partitions.
32. The method according to clause 29, wherein the encoding further comprises:
encoding an index indicating the shape of sub-partition.
33. The method according to clause 22, wherein the encoding further comprises:
obtaining an initial EIP extrapolation filter for the coding unit;
updating the initial EIP extrapolation filter to obtain an updated EIP extrapolation filter for a current sub-partition by using reconstructed samples from at least one previous encoded sub-partitions;
encoding a first sub-partition using the EIP extrapolation filter; and
encoding the current sub-partition using the updated EIP extrapolation filter.
34. The method according to clause 33, wherein updating the initial EIP extrapolation filter to obtain the updated EIP extrapolation filter further comprises:
replacing samples in a reference area of the current sub-partition by the reconstructed samples to obtain updated reference samples and an updated reference area; and
updating the initial EIP extrapolation filter based on the updated reference samples and the updated reference area to obtain the updated EIP extrapolation filter.
35. The method according to clause 34, wherein a clip range of the updated reference samples is updated based on the updated reference area.
36. The method according to clause 33, wherein the encoding further comprises:
encoding a flag indicating whether to update the initial EIP extrapolation filter.
37. The method according to clause 36, wherein the encoding further comprises:
determining whether to use the updated EIP extrapolation filter based on a template matching (TM) cost.
38. The method according to clause 37, wherein the encoding further comprises:
obtaining a first TM cost by applying the initial EIP extrapolation filter on a template region;
obtaining a second TM cost by applying the updated EIP extrapolation filter on the template region;
comparing the first TM cost and the second TM cost; and
in response to the second TM cost being smaller than the first TM cost, determining to use the updated EIP extrapolation filter for the current sub-partition.
39. The method according to clause 33, wherein the initial EIP extrapolation filter is inherited from an EIP merge list.
40. The method according to clause 33, wherein the initial EIP extrapolation filter is derived from the coding unit.
41. The method according to clause 33, wherein the encoding further comprises:
obtaining an initial first EIP extrapolation filter by deriving from template regions;
updating the initial first EIP extrapolation filter to obtain an updated first EIP extrapolation filter;
obtaining an initial second EIP extrapolation filter by inherited from an EIP merge list;
updating the initial second EIP extrapolation filter to obtain an updated second EIP extrapolation filter;
obtaining TM costs for the initial first EIP extrapolation filter, the updated first EIP extrapolation filter, the initial second EIP extrapolation filter, and the updated second EIP extrapolation filter based on TM costs, respectively; and
determining a final EIP extrapolation filter based on the TM costs.
42. The method according to clause 22, wherein an EIP fusion mode is applied, the EIP fusion mode comprises:
   obtaining a first predictor by an extrapolation filter-based intra prediction (EIP) mode;
   obtaining a second predictor by an intra prediction mode;
   generating a fused predictor by fusing the first predictor and the second predictor; and
   predicting one or more pictures using the fused predictor.
43. The method according to clause 42, wherein at least one of the first predictor and the second predictor is obtained at a sub-partition level, and the fused predictor is generated at the sub-partition level or a block level.
44. The method according to clause 43, wherein transform kernels of the EIP mode and the intra prediction mode are independent.
45. The method according to clause 43, wherein transform kernels of the EIP mode and the intra prediction mode are the same.
46. A method for decoding a bitstream, the method comprising:
receiving a bitstream; and
decoding the bitstream to output a video sequence using an extrapolation filter-based intra prediction (EIP) fusion mode, wherein decoding the bitstream using the EIP fusion mode comprises:
   obtaining a first predictor by an extrapolation filter-based intra prediction (EIP) mode;
   obtaining a second predictor by an intra prediction mode;
   generating a fused predictor by fusing the first predictor and the second predictor; and
   predicting one or more pictures using the fused predictor.
47. The method according to clause 46, wherein generating the fused predictor by fusing the first predictor and the second predictor further comprises:
   weighted combining the first predictor and the second predictor using a fusion weight.
48. The method according to clause 47, wherein the fusion weight is selected from at least one set of:
   {1/8, 2/8, 3/8, 4/8, 5/8, 6/8, 7/8};
   {1/16, 2/16, 3/16, 4/16, 5/16, 6/16, 7/16, 8/16, 9/16, 10/16, 11/16, 12/16, 13/16, 14/16, 15/16};
   {4/8, 5/8, 6/8, 7/8}; or
   {-4/8, 1/8, 2/8, 3/8, 4/8, 5/8, 6/8, 7/8}.
49. The method according to clause 47, wherein the fusion weight is 6/8 or −1/2.
50. The method according to clause 47, wherein the decoding further comprises:
decdong a fusion weight index indicating the fusion weight.
51. The method according to clause 47, wherein the decoding further comprises:
determining the fusion weight based on a template matching cost.
52. The method according to clause 46, wherein the decoding further comprises:
decoding a fusion flag indicating whether to use the EIP fusion mode.
53. The method according to clause 52, wherein the fusion flag is encoded for each EIP prediction candidate respectively.
54. The method according to clause 46, wherein the decoding further comprises:
determining whether to use the EIP fusion mode based on a block size of a coding unit (CU).
55. The method according to clause 46, wherein the decoding further comprises:
determining whether to use the EIP fusion mode based on template matching (TM) costs.
56. The method according to clause 55, wherein determining whether to use the EIP fusion mode based on the TM costs further comprises:
obtaining a first TM cost by testing the EIP mode on a template;
obtaining a second TM cost by testing the EIP fusion mode on the template; and
determining to use the EIP fusion mode when the second TM cost is smaller than the first TM cost.
57. The method according to clause 56, wherein the EIP fusion mode is tested on partial EIP prediction candidates.
58. The method according to clause 55, wherein determining whether to use the EIP fusion mode based on the TM costs further comprises:
obtaining a plurality of first TM costs, each first TM cost corresponding to an EIP prediction candidate;
obtaining a plurality of second TM costs, each second TM cost corresponding to a EIP fusion prediction candidate, wherein the EIP fusion prediction candidate is obtained based on an EIP prediction candidate and a fusion weight;
sorting the plurality of first TM costs and the plurality of second TM costs in an ascending order; and
selecting a prediction candidate with the smallest TM cost to be a final prediction candidate.
59. The method according to clause 47, wherein the decoding further comprises:
decoding a fusion flag indicating whether to use the EIP fusion mode; and
decoding a fusion weight index indicating the fusion weight; wherein the fusion flag and the fusion weight index are inherited from merge candidates in an EIP merge mode.
60. The method according to clause 46, wherein the decoding further comprises:
dividing a coding unit into two or more sub-partitions based on a shape of sub-partition; and
performing EIP prediction process on the two or more sub-partitions sequentially.
61. The method according to clause 60, wherein at least one of the first predictor and the second predictor is obtained at a sub-partition level, and the fused predictor is generated at the sub-partition level or a block level.
62. The method according to clause 61, wherein transform kernels of the EIP mode and the intra prediction mode are independent.
63. The method according to clause 61, wherein transform kernels of the EIP mode and the intra prediction mode are the same.
64. The method according to clause 46, wherein the intra prediction mode comprises at least one of a planar mode, an angular mode, and a DC mode.
65. The method according to clause 64, wherein the intra prediction mode is the angular mode, and the second predictor is derived by a Decoder-side Intra Mode Derivation (DIMD) mode with neighboring reconstructed samples.
66. The method according to clause 65, wherein the second predictor is a predictor with highest histogram of gradient (HoG) amplitude.
67. A method for decoding a bitstream, the method comprising:
receiving a bitstream; and
decoding the bitstream to output a video sequence, the decoding comprising:
   dividing a coding unit into two or more sub-partitions based on a shape of sub-partition; and
   performing extrapolation filter-based intra prediction (EIP) process on the two or more sub-partitions sequentially.
68. The method according to clause 67, wherein the decoding further comprises:
   deriving an EIP extrapolation filter from template regions;
   predicting a first partition of the two or more sub-partitions using the EIP extrapolation filter to obtain first constructed samples;
   taking the first constructed samples as reference samples for a second partition of the two or more sub-partitions; and
   predicting the second partition based on the first constructed samples using the EIP extrapolation filter.
69. The method according to clause 67, wherein the EIP extrapolation filter is inherited from blocks in an EIP merge list.
70. The method according to clause 69, wherein the shape of sub-partition is inherited from the blocks in the EIP merge list.
71. The method according to clause 69, wherein the shape of sub-partition is determined based on a filter shape, a template type, and a block size of the coding unit.
72. The method according to clause 67, wherein the shape of sub-partition is determined based on a filter shape, a template type, and a block size of the coding unit.
73. The method according to clause 72, wherein the shape of sub-partition comprises a sub-partition direction and a number of sub-partitions, the sub-partition direction is determined based on the filter shape and the template type, and the number of sub-partitions is determined based on the block size.
74. The method according to clause 67, wherein the decoding further comprises:
decoding a first flag indicating whether the two or more sub-partitions are enabled.
75. The method according to clause 74, wherein the shape of sub-partition comprises a sub-partition direction and a number of sub-partitions and the decoding further comprises:
in response to the first flag indicating the two or more sub-partitions are enabled, decoding a second flag indicating the sub-partition direction of the shape of sub-partition.
76. The method according to clause 75, wherein the decoding further comprises:
decoding an index indicating the number of sub-partitions.
77. The method according to clause 74, wherein the decoding further comprises:
decoding an index indicating the shape of sub-partition.
78. The method according to clause 67, wherein the decoding further comprises:
obtaining an initial EIP extrapolation filter for the coding unit;
updating the initial EIP extrapolation filter to obtain an updated EIP extrapolation filter for a current sub-partition by using reconstructed samples from at least one previous decoded sub-partitions;
decoding a first sub-partition using the EIP extrapolation filter; and
decoding the current sub-partition using the updated EIP extrapolation filter.
79. The method according to clause 78, wherein updating the initial EIP extrapolation filter to obtain the updated EIP extrapolation filter further comprises:
replacing samples in a reference area of the current sub-partition by the reconstructed samples to obtain updated reference samples and an updated reference area; and
updating the initial EIP extrapolation filter based on the updated reference samples and the updated reference area to obtain the updated EIP extrapolation filter.
80. The method according to clause 79, wherein a clip range of the updated reference samples is updated based on the updated reference area.
81. The method according to clause 78, wherein the decoding further comprises:
decoding a flag indicating whether to update the initial EIP extrapolation filter.
82. The method according to clause 81, wherein the decoding further comprises:
determining whether to use the updated EIP extrapolation filter based on a template matching (TM) cost.
83. The method according to clause 82, wherein the decoding further comprises:
obtaining a first TM cost by applying the initial EIP extrapolation filter on a template region;
obtaining a second TM cost by applying the updated EIP extrapolation filter on the template region;
comparing the first TM cost and the second TM cost; and
in response to the second TM cost being smaller than the first TM cost, determining to use the updated EIP extrapolation filter for the current sub-partition.
84. The method according to clause 78, wherein the initial EIP extrapolation filter is inherited from an EIP merge list.
85. The method according to clause 78, wherein the initial EIP extrapolation filter is derived from the coding unit.
86. The method according to clause 78, wherein the decoding further comprises:
obtaining an initial first EIP extrapolation filter by deriving from template regions; updating the initial first EIP extrapolation filter to obtain an updated first EIP extrapolation filter;
obtaining an initial second EIP extrapolation filter by inherited from an EIP merge list;
updating the initial second EIP extrapolation filter to obtain an updated second EIP extrapolation filter;
obtaining TM costs for the initial first EIP extrapolation filter, the updated first EIP extrapolation filter, the initial second EIP extrapolation filter, and the updated second EIP extrapolation filter based on TM costs, respectively; and
determining a final EIP extrapolation filter based on the TM costs.
87. The method according to clause 67, wherein an EIP fusion mode is applied, the EIP fusion mode comprises:
   obtaining a first predictor by an extrapolation filter-based intra prediction (EIP) mode;
   obtaining a second predictor by an intra prediction mode;
   generating a fused predictor by fusing the first predictor and the second predictor; and
   predicting one or more pictures using the fused predictor.
88. The method according to clause 87, wherein at least one of the first predictor and the second predictor is obtained at a sub-partition level, and the fused predictor is generated at the sub-partition level or a block level.
89. The method according to clause 88, wherein transform kernels of the EIP mode and the intra prediction mode are independent.
90. The method according to clause 88, wherein transform kernels of the EIP mode and the intra prediction mode are the same.
91. A method for signaling a bitstream, the method comprising:
receiving a video sequence;
encoding the video sequence using an extrapolation filter-based intra prediction (EIP) fusion mode, wherein encoding the video sequence using the EIP fusion mode comprises:
   obtaining a first predictor by an extrapolation filter-based intra prediction (EIP) mode;
   obtaining a second predictor by an intra prediction mode;
   generating a fused predictor by fusing the first predictor and the second predictor; and
   predicting one or more pictures using the fused predictor; and
signaling a bitstream that is generated based on the encoding.
92. The method according to clause 91, wherein generating the fused predictor by fusing the first predictor and the second predictor further comprises:
   weighted combining the first predictor and the second predictor using a fusion weight.
93. The method according to clause 92, wherein the fusion weight is selected from at least one set of:
{1/8, 2/8, 3/8, 4/8, 5/8, 6/8, 7/8};
{1/16, 2/16, 3/16, 4/16, 5/16, 6/16, 7/16, 8/16, 9/16, 10/16, 11/16, 12/16, 13/16, 14/16, 15/16};
{4/8, 5/8, 6/8, 7/8}; or
{-4/8, 1/8, 2/8, 3/8, 4/8, 5/8, 6/8, 7/8}.
94. The method according to clause 92, wherein the fusion weight is 6/8 or −1/2.
95. The method according to clause 92, wherein the encoding further comprises:
encoding a fusion weight index indicating the fusion weight.
96. The method according to clause 92, wherein the encoding further comprises:
determining the fusion weight based on a template matching cost.
97. The method according to clause 91, wherein the encoding further comprises:
encoding a fusion flag indicating whether to use the EIP fusion mode.
98. The method according to clause 97, wherein the fusion flag is encoded for each EIP prediction candidate respectively.
99. The method according to clause 91, wherein the encoding further comprises:
determining whether to use the EIP fusion mode based on a block size of a coding unit (CU).
100. The method according to clause 91, wherein the encoding further comprises:
determining whether to use the EIP fusion mode based on template matching (TM) costs.
101. The method according to clause 100, wherein determining whether to use the EIP fusion mode based on the TM costs further comprises:
obtaining a first TM cost by testing the EIP mode on a template;
obtaining a second TM cost by testing the EIP fusion mode on the template; and
determining to use the EIP fusion mode when the second TM cost is smaller than the first TM cost.
102. The method according to clause 101, wherein the EIP fusion mode is tested on partial EIP prediction candidates.
103. The method according to clause 100, wherein determining whether to use the EIP fusion mode based on the TM costs further comprises:
obtaining a plurality of first TM costs, each first TM cost corresponding to an EIP prediction candidate;
obtaining a plurality of second TM costs, each second TM cost corresponding to a EIP fusion prediction candidate, wherein the EIP fusion prediction candidate is obtained based on an EIP prediction candidate and a fusion weight;
sorting the plurality of first TM costs and the plurality of second TM costs in an ascending order; and
selecting a prediction candidate with the smallest TM cost to be a final prediction candidate.
104. The method according to clause 92, wherein the encoding further comprises:
encoding a fusion flag indicating whether to use the EIP fusion mode; and
encoding a fusion weight index indicating the fusion weight; wherein the fusion flag and the fusion weight index are inherited from merge candidates in an EIP merge mode.
105. The method according to clause 91, wherein the encoding further comprises:
dividing a coding unit into two or more sub-partitions based on a shape of sub-partition; and
performing EIP prediction process on the two or more sub-partitions sequentially.
106. The method according to clause 105, wherein at least one of the first predictor and the second predictor is obtained at a sub-partition level, and the fused predictor is generated at the sub-partition level or a block level.
107. The method according to clause 106, wherein transform kernels of the EIP mode and the intra prediction mode are independent.
108. The method according to clause 106, wherein transform kernels of the EIP mode and the intra prediction mode are the same.
109. The method according to clause 91, wherein the intra prediction mode comprises at least one of a planar mode, an angular mode, and a DC mode.
110. The method according to clause 109, wherein the intra prediction mode is the angular mode, and the second predictor is derived by a Decoder-side Intra Mode Derivation (DIMD) mode with neighboring reconstructed samples.
111. The method according to clause 110, wherein the second predictor is a predictor with highest histogram of gradient (HoG) amplitude.
112. A method for signaling a bitstream, the method comprising:
receiving a video sequence;
encoding the video sequence by:
   dividing a coding unit into two or more sub-partitions based on a shape of sub-partition; and
   performing extrapolation filter-based intra prediction (EIP) process on the two or more sub-partitions sequentially; and
signaling a bitstream that is generated based on the encoding.
113. The method according to clause 112, wherein the encoding further comprises:
   deriving an EIP extrapolation filter from template regions;
   predicting a first partition of the two or more sub-partitions using the EIP extrapolation filter to obtain first constructed samples;
   taking the first constructed samples as reference samples for a second partition of the two or more sub-partitions; and
   predicting the second partition based on the first constructed samples using the EIP extrapolation filter.
114. The method according to clause 112, wherein the EIP extrapolation filter is inherited from blocks in an EIP merge list.
115. The method according to clause 114, wherein the shape of sub-partition is inherited from the blocks in the EIP merge list.
116. The method according to clause 114, wherein the shape of sub-partition is determined based on a filter shape, a template type, and a block size of the coding unit.
117. The method according to clause 112, wherein the shape of sub-partition is determined based on a filter shape, a template type, and a block size of the coding unit.
118. The method according to clause 117, wherein the shape of sub-partition comprises a sub-partition direction and a number of sub-partitions, the sub-partition direction is determined based on the filter shape and the template type, and the number of sub-partitions is determined based on the block size.
119. The method according to clause 112, wherein the encoding further comprises:
encoding a first flag indicating whether the two or more sub-partitions are enabled.
120. The method according to clause 119, wherein the shape of sub-partition comprises a sub-partition direction and a number of sub-partitions and the encoding further comprises:
in response to the first flag indicating the two or more sub-partitions are enabled, encoding a second flag indicating the sub-partition direction of the shape of sub-partition.
121. The method according to clause 120, wherein the encoding further comprises:
encoding an index indicating the number of sub-partitions.
122. The method according to clause 119, wherein the encoding further comprises:
encoding an index indicating the shape of sub-partition.
123. The method according to clause 112, wherein the encoding further comprises:
obtaining an initial EIP extrapolation filter for the coding unit;
updating the initial EIP extrapolation filter to obtain an updated EIP extrapolation filter for a current sub-partition by using reconstructed samples from at least one previous encoded sub-partitions;
encoding a first sub-partition using the EIP extrapolation filter; and
encoding the current sub-partition using the updated EIP extrapolation filter.
124. The method according to clause 123, wherein updating the initial EIP extrapolation filter to obtain the updated EIP extrapolation filter further comprises:
replacing samples in a reference area of the current sub-partition by the reconstructed samples to obtain updated reference samples and an updated reference area; and
updating the initial EIP extrapolation filter based on the updated reference samples and the updated reference area to obtain the updated EIP extrapolation filter.
125. The method according to clause 124, wherein a clip range of the updated reference samples is updated based on the updated reference area.
126. The method according to clause 123, wherein the encoding further comprises:
encoding a flag indicating whether to update the initial EIP extrapolation filter.
127. The method according to clause 126, wherein the encoding further comprises:
determining whether to use the updated EIP extrapolation filter based on a template matching (TM) cost.
128. The method according to clause 127, wherein the encoding further comprises:
obtaining a first TM cost by applying the initial EIP extrapolation filter on a template region;
obtaining a second TM cost by applying the updated EIP extrapolation filter on the template region;
comparing the first TM cost and the second TM cost; and
in response to the second TM cost being smaller than the first TM cost, determining to use the updated EIP extrapolation filter for the current sub-partition.
129. The method according to clause 123, wherein the initial EIP extrapolation filter is inherited from an EIP merge list.
130. The method according to clause 123, wherein the initial EIP extrapolation filter is derived from the coding unit.
131. The method according to clause 123, wherein the encoding further comprises:
obtaining an initial first EIP extrapolation filter by deriving from template regions; updating the initial first EIP extrapolation filter to obtain an updated first EIP extrapolation filter;
obtaining an initial second EIP extrapolation filter by inherited from an EIP merge list;
updating the initial second EIP extrapolation filter to obtain an updated second EIP extrapolation filter;
obtaining TM costs for the initial first EIP extrapolation filter, the updated first EIP extrapolation filter, the initial second EIP extrapolation filter, and the updated second EIP extrapolation filter based on TM costs, respectively; and
determining a final EIP extrapolation filter based on the TM costs.
132. The method according to clause 112, wherein an EIP fusion mode is applied, the EIP fusion mode comprises:
   obtaining a first predictor by an extrapolation filter-based intra prediction (EIP) mode;
   obtaining a second predictor by an intra prediction mode;
   generating a fused predictor by fusing the first predictor and the second predictor; and
   predicting one or more pictures using the fused predictor.
133. The method according to clause 132, wherein at least one of the first predictor and the second predictor is obtained at a sub-partition level, and the fused predictor is generated at the sub-partition level or a block level.
134. The method according to clause 133, wherein transform kernels of the EIP mode and the intra prediction mode are independent.
135. The method according to clause 133, wherein transform kernels of the EIP mode and the intra prediction mode are the same.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method of encoding a video sequence, the method comprising:
receiving a video sequence;
encoding the video sequence using an extrapolation filter-based intra prediction (EIP) fusion mode, wherein encoding the video sequence using the EIP fusion mode comprises:
obtaining a first predictor by an extrapolation filter-based intra prediction (EIP) mode;
obtaining a second predictor by an intra prediction mode;
generating a fused predictor by fusing the first predictor and the second predictor; and
predicting one or more pictures using the fused predictor.

2. The method according to claim 1, wherein generating the fused predictor by fusing the first predictor and the second predictor further comprises:
weighted combining the first predictor and the second predictor using a fusion weight.

3. The method according to claim 2, wherein the encoding further comprises:
encoding a fusion weight index indicating the fusion weight.

4. The method according to claim 2, wherein the encoding further comprises:
determining the fusion weight based on a template matching cost.

5. The method according to claim 1, wherein the encoding further comprises:
determining whether to use the EIP fusion mode based on a block size of a coding unit (CU).

6. The method according to claim 1, wherein the encoding further comprises:
determining whether to use the EIP fusion mode based on template matching (TM) costs.

7. The method according to claim 1, wherein the encoding further comprises:
dividing a coding unit into two or more sub-partitions based on a shape of sub-partition; and
performing EIP prediction process on the two or more sub-partitions sequentially.

8. A method for decoding a bitstream, the method comprising:
receiving a bitstream; and
decoding the bitstream to output a video sequence using an extrapolation filter-based intra prediction (EIP) fusion mode, wherein decoding the bitstream using the EIP fusion mode comprises:
obtaining a first predictor by an extrapolation filter-based intra prediction (EIP) mode;
obtaining a second predictor by an intra prediction mode;
generating a fused predictor by fusing the first predictor and the second predictor; and
predicting one or more pictures using the fused predictor.

9. The method according to claim 8, wherein generating the fused predictor by fusing the first predictor and the second predictor further comprises:
weighted combining the first predictor and the second predictor using a fusion weight.

10. The method according to claim 9, wherein the decoding further comprises:
decoding a fusion weight index indicating the fusion weight.

11. The method according to claim 9, wherein the decoding further comprises:
determining the fusion weight based on a template matching cost.

12. The method according to claim 8, wherein the decoding further comprises:
determining whether to use the EIP fusion mode based on a block size of a coding unit (CU).

13. The method according to claim 8, wherein the decoding further comprises:
determining whether to use the EIP fusion mode based on template matching (TM) costs.

14. The method according to claim 8, wherein the decoding further comprises:
dividing a coding unit into two or more sub-partitions based on a shape of sub-partition; and
performing EIP prediction process on the two or more sub-partitions sequentially.

15. A method for signaling a bitstream, the method comprising:
receiving a video sequence;
encoding the video sequence using an extrapolation filter-based intra prediction (EIP) fusion mode, wherein encoding the video sequence using the EIP fusion mode comprises:
obtaining a first predictor by an extrapolation filter-based intra prediction (EIP) mode;
obtaining a second predictor by an intra prediction mode;
generating a fused predictor by fusing the first predictor and the second predictor; and
predicting one or more pictures using the fused predictor; and
signaling a bitstream that is generated based on the encoding.

16. The method according to claim 15, wherein generating the fused predictor by fusing the first predictor and the second predictor further comprises:
weighted combining the first predictor and the second predictor using a fusion weight.

17. The method according to claim 16, wherein the encoding further comprises:
determining the fusion weight based on a template matching cost.

18. The method according to claim 15, wherein the encoding further comprises:
determining whether to use the EIP fusion mode based on a block size of a coding unit (CU).

19. The method according to claim 15, wherein the encoding further comprises:
determining whether to use the EIP fusion mode based on template matching (TM) costs.

20. The method according to claim 15, wherein the encoding further comprises:
dividing a coding unit into two or more sub-partitions based on a shape of sub-partition; and
performing EIP prediction process on the two or more sub-partitions sequentially.
